(19) United States
(12) Patent Application Publication
(10) Pub. No.: US 2016/0301731 A1
(43) Pub. Date: Oct. 13, 2016

(54) SYSTEMS AND METHODS FOR CONDUCTING REVERSE AUCTIONS TO IMPROVE QOE OF NETWORKED APPLICATIONS

(71) Applicant: InterDigital Patent Holdings, Inc., Wilmington, DE (US)

(72) Inventors: Shoshana LOEB, Philadelphia, PA (US); John D. KAEWELL, Jamison, PA (US)

(21) Appl. No.: 15/100,615

(22) PCT Filed: Nov. 24, 2014
(86) PCT No.: PCT/US2014/067161

§ 371 Date: May 31, 2016

Related U.S. Application Data
(60) Provisional application No. 61/910,427, filed on Dec. 1, 2013.

(51) Int. Cl. H04L 29/06; G06Q 30/06

(52) U.S. Cl. CPC H04L 65/80; H04L 65/403; G06Q 30/0611

(57) ABSTRACT

Systems and methods are disclosed for conducting reverse auctions to improve the quality of experience (QoE) of networked applications, such as multi-player networked games. From among plurality of participants in a networked application, a participant with a low quality of experience is identified. A service is identified that is predicted to improve the participant's quality of experience, and a plurality of service providers are identified who are capable of providing the identified network service. An auction server then conducts a reverse auction for the identified network service. The network service may be, for example, an application service or a connectivity service.

### CROSS-REFERENCE TO RELATED APPLICATIONS

The present application is a non-provisional filing of, and claims benefit under 35 U.S.C. §119(e) from, U.S. Provisional Patent Application Ser. No. 61/910,427, filed Dec. 1, 2013, incorporated herein by reference in its entirety.

### FIELD

This disclosure relates to distributed multi-user applications, such as distributed multiplayer games.

### BACKGROUND

People use many types of communication devices to access and communicate via many types of networks. Such devices include computers (e.g., desktops, laptops), tablets, smartphones, personal digital assistants (PDAs), cell phones, and the like. In the balance of this disclosure, these devices are referred to as access terminals (ATs) whether they engage in wired communication, wireless communication, or both.

These ATs engage in packet-data communication with one or more other entities (other ATs, servers, gateways, and the like), and quite often the communication path involves the worldwide network of networks that is typically referred to as the Internet. In such cases, it is typical that a given AT, either automatically or at the request of a user, accesses the Internet (and/or one or more other transport and/or signaling networks) via one or more of what are referred to in this disclosure as connectivity providers (CPs), which are also often referred to as Internet Service Providers (ISPs), access networks, and the like.

In various instances, CPs provide connectivity using one or more network-access technologies such as digital subscriber line (DSL) modems, cable modems, satellite-based data communication, Wi-Fi networks, Wi-Fi access points, mobile networks, and the like. A given mobile network could be or include a cellular wireless network operating according to a wireless-communication format such as code division multiple access (CDMA), time division multiple access (TDMA), frequency division multiple access (FDMA), orthogonal frequency division multiple access (OFDMA), Evolution Data Optimized (EV-DO), Long Term Evolution (LTE), WiMAX, and the like.

Typically, an AT gains connectivity via a given CP either for free, in exchange for a one-time payment, in exchange for a paid-for subscription, and/or according to some other arrangement. Moreover, many ATs are able to access the Internet via multiple different CPs. For example, a tablet computer may be able to engage in (i) LTE communication via a first CP and (ii) Wi-Fi communication via any number of different Wi-Fi networks, perhaps including a home network connected via a cable modem to a second CP, as well as other Wi-Fi networks that are connected to the Internet via still other CPs. And certainly many other examples could be given as well, whether the corresponding ATs engage in wired (e.g., Ethernet) communication, wireless (e.g., LTE, Wi-Fi, etc.) communication, or both.

Once connected, ATs (e.g., users via ATs) engage in numerous different types of data communication, including Voice over Internet Protocol (IP) (VoIP), instant messaging, web browsing, gaming, gambling, virtual attendance at online meetings of varying levels of audiovisual sophistication, streaming audio, streaming video, and the like. ATs often engage in these various types of data communication as part of executing, running, participating in, etc. various applications. In general, computing devices such as ATs commonly execute a wide variety of applications. When applications involve an online aspect (e.g., online gaming), such applications are often referred to as networked applications, a categorization that includes both (i) Internet-hosted applications (accessible via, e.g., web-browsing applications) and (ii) native AT applications (e.g., mobile applications (or apps)), which are often downloaded to, installed on, and then executed by a given AT.

### SUMMARY

For a given participant or group of participants, each using a respective AT, in a networked application (e.g., a multi-player networked game), one metric that is often sought to be maximized by the application provider, the relevant CP, and of course the players themselves is quality of experience (QoE (or sometimes QX)). QoE is a metric of a given user's level of satisfaction, enjoyment, and the like offset by the user's dissatisfaction, frustration, being unimpressed, and the like. Some factors that can contribute to a given (superb or poor) QoE result are data latency, system crashes, communication failures (perhaps necessitating reconnection procedures), responsiveness to player inputs, and the like.

The presently disclosed systems and methods involve conducting auctions, in particular reverse auctions, in order to improve the QoE of networked applications. In a traditional auction, potential buyers compete to purchase a good or service. In a reverse auction, potential sellers compete to sell a particular good or service. In a reverse auction, the competitive bidding process tends to drive the eventual actual buying price down. In particular, the present systems and methods enable dynamic selection (by users and/or groups of users) of CPs and/or application providers whose respective connectivity services and/or application-providing services impact the performance of a networked application, and thus the QoE of users (e.g., players) of the network application.

One embodiment takes the form of a method carried out by an auction server that includes a communication module, a general processing module, and a general data-storage module containing program instructions executable by the general processing module for carrying out the method, which involves identifying a potential buyer of a service, where the potential buyer is a participant in a networked application. The method further involves identifying candidate sellers of the service. The method further involves making a market between the identified potential buyer and a subset of the identified candidate sellers. The method further involves conducting a reverse auction for the service between (i) the identified potential buyer and (ii) the subset of identified candidate sellers, where conducting the reverse auction includes selecting a winning seller. The method further involves settling all related transactions.

Some embodiments take the form of an auction server that includes a communication module, a general processing module, and a general data-storage module containing program instructions executable by the general processing module for carrying out the method, which involves using a buyer-identifier module for identifying a potential buyer of a service, where the potential buyer is a participant in a networked application. The method further involves using a candidate-sellers-identifier module for identifying candidate sellers of the service. The method further involves using a market-maker module for making a market between the identified potential buyer and a subset of the identified candidate sellers. The method further involves using an auction-conductor module for conducting a reverse auction for the service between (i) the identified potential buyer and (ii) the subset of identified candidate sellers, where conducting the reverse auction includes selecting a winning seller. The method further involves using a transaction-settler module for settling all related transactions.

In at least one embodiment, identifying the potential buyer of the service involves determining at least a state of the networked application, and further involves identifying the service based at least in part on the determined state of the networked application. In at least one such embodiment, the determined state of the networked application includes an end-to-end state of the networked application. In at least another such embodiment, the determined state of the networked application includes a state of an application server providing the networked application. In at least another such embodiment, the determined state of the networked application includes a state of at least one network via which the networked application is being provided. In at least another such embodiment, the determined state of the networked application includes a state of at least one current user of the networked application, the at least one current user including the potential buyer. In at least one such embodiment, the state of the buyer includes one or more of a user profile corresponding to the potential buyer, a type of equipment in use by the potential buyer in connection with the networked application, a type of data connection in use by the potential buyer in connection with the networked application, a connection speed in use by the potential buyer in connection with the networked application, and a location of the potential buyer. In at least another such embodiment, the determined state of the networked application includes at least one of packet-delay data, packet-loss data, and jitter data.

In at least one embodiment, the service is an application service. In at least one embodiment, the service is a connectivity service. In at least one embodiment, the candidate sellers are application providers. In at least one embodiment, the candidate sellers are connectivity providers.

In at least one embodiment, making the market between the identified potential buyer and the subset of the identified candidate sellers involves notifying each of the identified candidate sellers of their respective invitation to participate in the reverse auction, and further involves including in the subset any identified candidate seller from which an acceptance of the corresponding invitation is received. In at least one such embodiment, notifying each of the identified candidate sellers of their respective invitation to participate in the reverse auction involves notifying each of the identified candidate sellers of one or more of an initial price for bids, state information regarding the networked application, and information defining the service.

In at least one embodiment, making the market between the identified potential buyer and the subset of the identified candidate sellers involves charging an auction-participation fee to each identified candidate seller in the subset.

In at least one embodiment, the subset of identified candidate sellers includes some but not all of the identified candidate sellers. In at least one embodiment, the subset of identified candidate sellers includes all of the identified candidate sellers. In at least one embodiment, the reverse auction is an English reverse auction. In at least one embodiment, the reverse auction is a Dutch reverse auction. In at least one embodiment, the winning seller provides the purchased service to the buyer.

In at least one embodiment, settling all related transactions includes the buyer remitting an auction fee to the auction server. In at least one embodiment, settling all related transactions includes the buyer remitting a service fee to the selected winning seller. In at least one embodiment, settling all related transactions involves performing auction settlement with the selected winning seller. In at least one embodiment, settling all related transactions involves finalizing a service contract that binds the selected winning seller to provide the service to the buyer according to terms agreed to by both the selected winning seller and the buyer. In at least one embodiment, settling all related transactions involves transmitting a work order for the service to the selected winning seller. In at least one embodiment, settling all related transactions involves carrying out a billing function. In at least one embodiment, settling all related transactions involves carrying out billing and reconciliation functions. In at least one embodiment, settling all related transactions involves conducting dispute resolution.

In at least one embodiment, the auction server provides a feedback-receiving function that involves storing at least one received feedback message. In at least one such embodiment, the auction server also provides at least the at least one received feedback message to a participant in a later reverse auction.

### BRIEF DESCRIPTION OF THE DRAWINGS

A more detailed understanding may be had from the following description, presented by way of example in conjunction with the accompanying drawings, wherein:

FIG. 1A is a schematic block diagram of a first exemplary communication system in which at least one embodiment can be implemented.

FIG. 1B is a functional block diagram of an exemplary access terminal that could be used in connection with at least one embodiment.

FIG. 1C is a schematic block diagram of a first arrangement of the first exemplary communication system.

FIG. 1D is a schematic block diagram of an arrangement of the first exemplary communication system.

FIG. 1E is a schematic block diagram of a third arrangement of the first exemplary communication system.

FIG. 1F is a schematic block diagram of a second communication system in which at least one embodiment can be implemented.

FIG. 2A is a schematic block diagram of a first view of a third exemplary communication system in which at least one embodiment can be implemented.

FIG. 2B is a schematic block diagram of a second view of the third exemplary communication system.

FIG. 3 is a functional block diagram of a server used in some embodiments.

FIG. 4 is a functional block diagram of an auction server in accordance with at least one embodiment.

FIG. 5 is a flow chart depicting a method in accordance with at least one embodiment.

FIG. 6 is a flow chart depicting a method in accordance with at least one embodiment.

FIG. 7 is a flow chart depicting a reverse English auction method in accordance with at least one embodiment.

FIG. 8 is a flow chart depicting a reverse Dutch auction method in accordance with at least one embodiment.

### DETAILED DESCRIPTION

A detailed description of illustrative embodiments will now be provided with reference to the various Figures. Although this description provides detailed examples of possible implementations, it should be noted that the provided details are intended to be by way of example and in no way to limit the scope of the application.

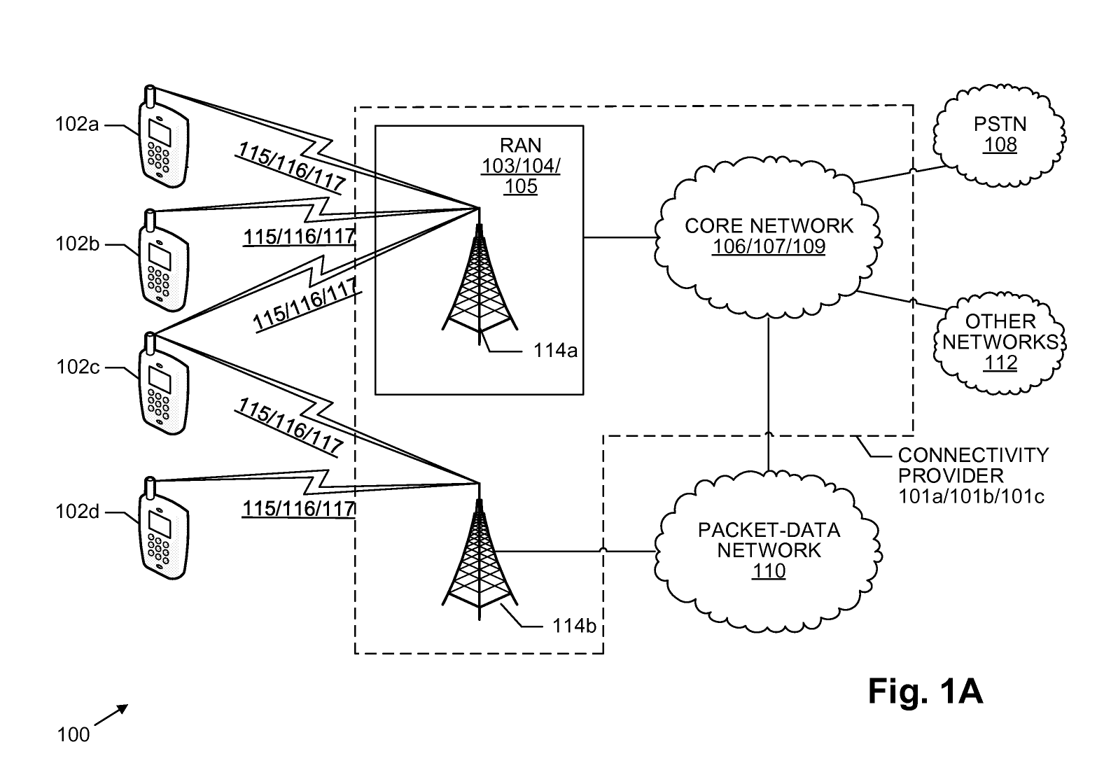

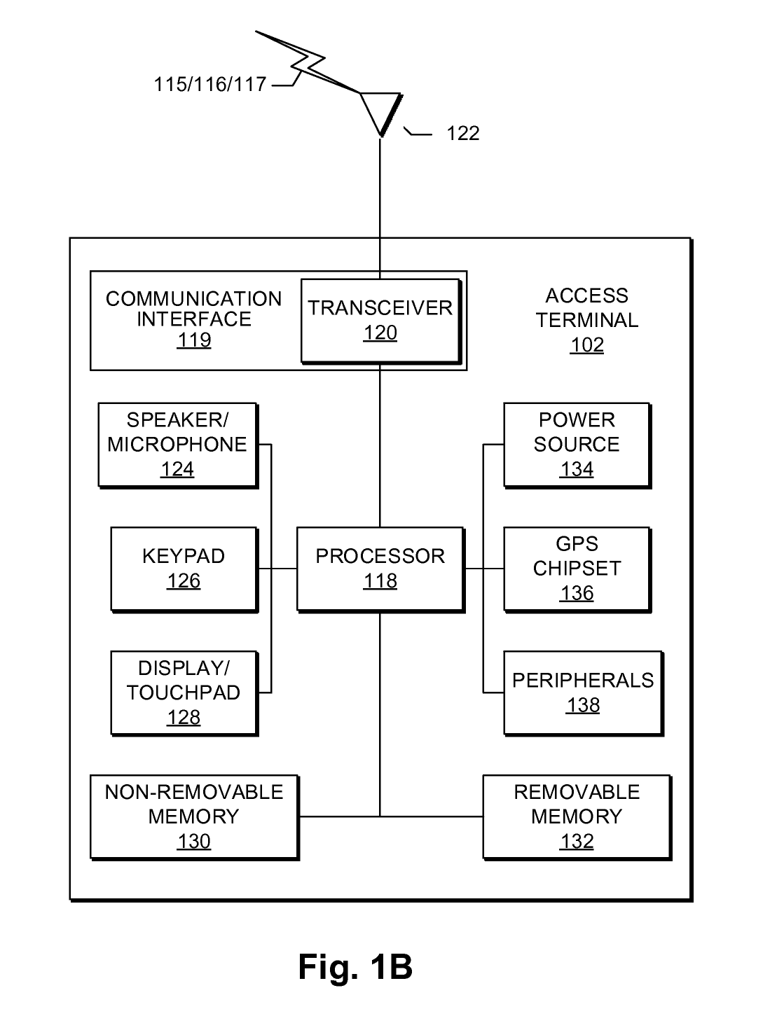

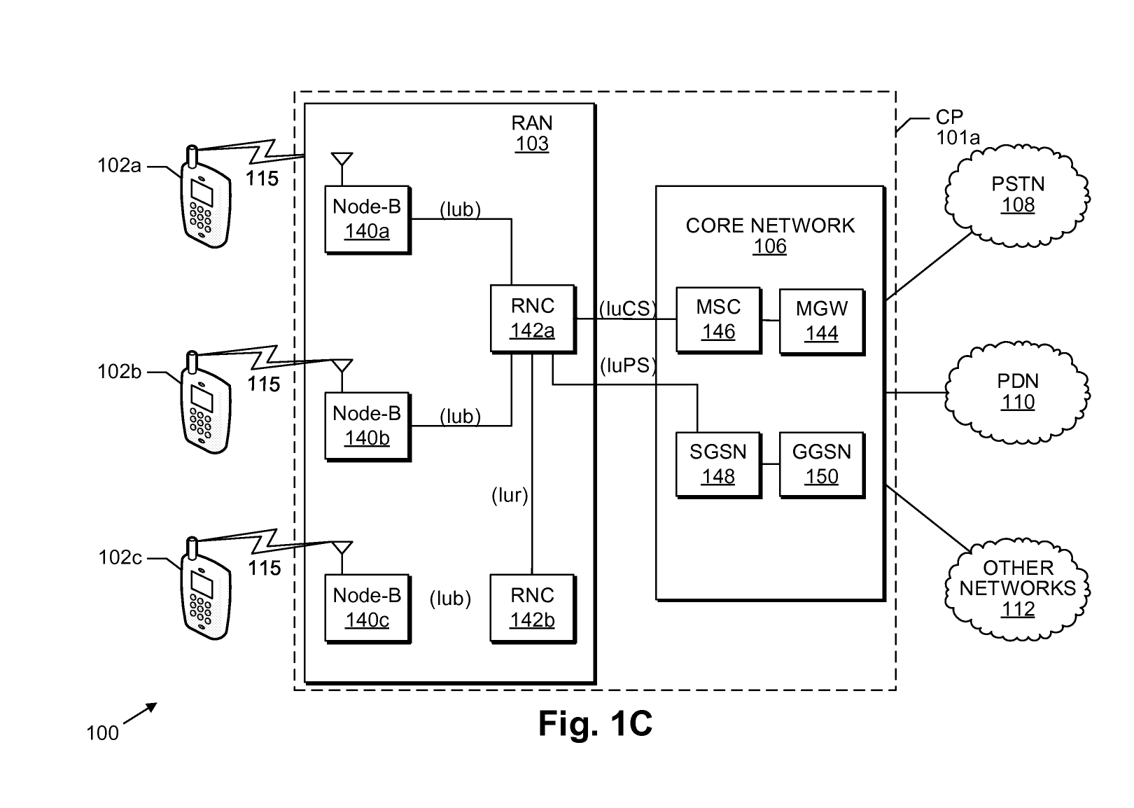

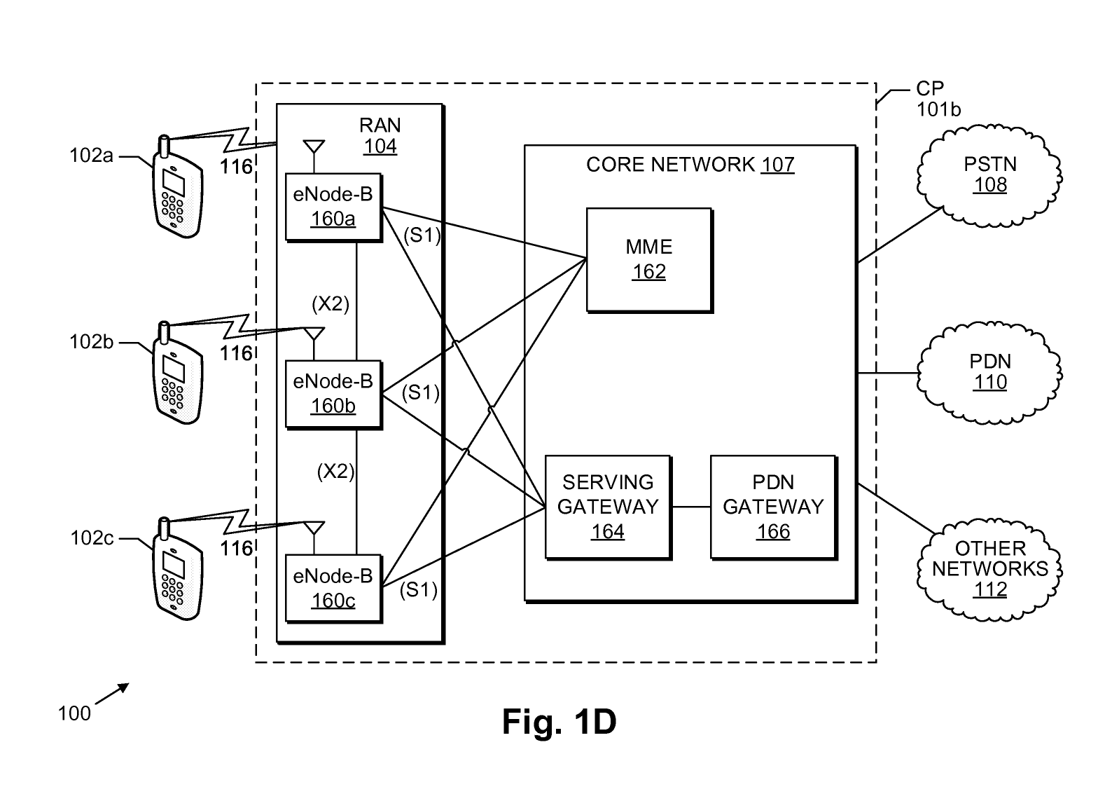

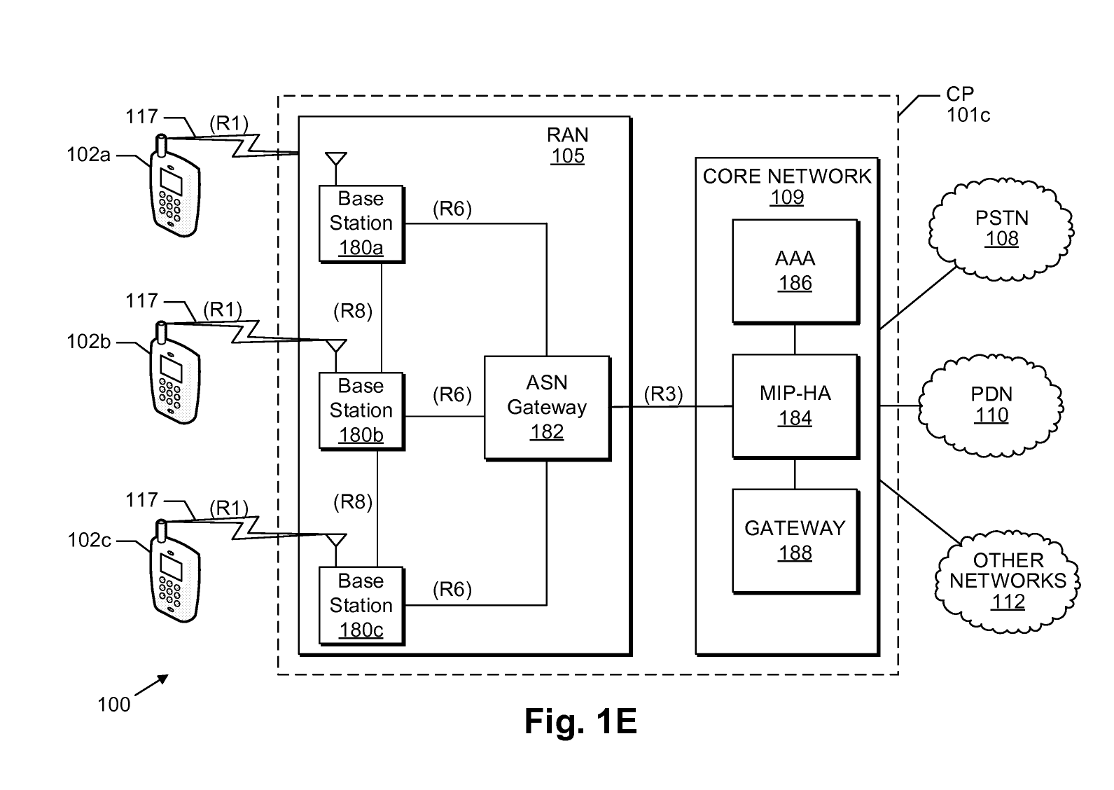

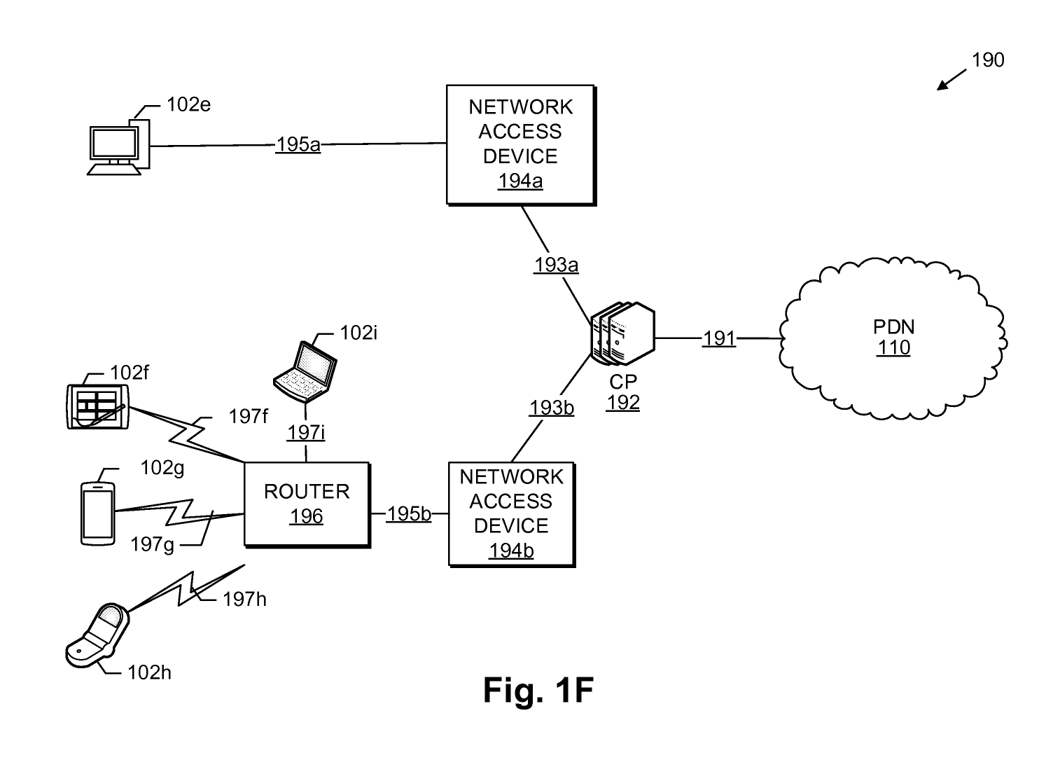

FIG. 1A depicts a first example communication system in which at least one embodiment can be implemented. Although the communication system 100 that is described in FIGS. 1A, 1C, 1D, and 1E involves wireless communications between ATs and respective CPs, this is by way of example and not limitation, as any suitable forms of wired and/or wireless communication could be employed in a given context. The communication system 100 may be a multiple access system that provides content, such as voice, data, video, messaging, broadcast, and the like, to multiple wireless users. The communications system 100 may enable multiple wireless users to access such content through the sharing of system resources, including wireless bandwidth. For example, the communications systems 100 may employ one or more channel-access methods, such as CDMA, TDMA, FDMA, OFDMA, single-carrier FDMA (SC-FDMA), and the like.

As shown in FIG. 1A, the communications system 100 may include ATs 102a, 102b, 102c, and/or 102d (which may generally, individually, or collectively be referred to herein as AT 102 and/or as ATs 102), a CP 101a/101b/101c (that itself includes a RAN 103/104/105, a core network 106/107/109, and a base station 114b), a public switched telephone network (PSTN) 108, a packet-data network (PDN) (e.g., the Internet) 110, and other networks 112, though it will be appreciated that the disclosed embodiments contemplate any number of ATs, base stations, networks, and/or network elements. Each of the ATs 102 may be any type of device configured to operate and/or communicate in a wireless environment. By way of example, the ATs 102 may be configured to transmit and/or receive wireless signals and may include user equipment (UE), a mobile station, a fixed or mobile subscriber unit, a pager, a cellular telephone, a PDA, a smartphone, a laptop, a netbook, a personal computer, a wireless sensor, consumer electronics, and the like.

The CP 101a/101b/101c may also include a base station 114a and the base station 114b. Each of the base stations 114a, 114b may be any type of device configured to wirelessly interface with at least one of the ATs 102 to facilitate access to one or more communication networks, such as the core network 106/107/109, the PDN 110, and/or the other networks 112. By way of example, one or both of the base stations 114a, 114b may be a base transceiver station (BTS), a Node-B, an eNode B, a Home Node B, a Home eNode B, a site controller, an access point, a wireless router, and the like. While the base stations 114a, 114b are each depicted as being a single element, either or both may include any number of interconnected base stations and/or network elements.

The base station 114a may be part of the RAN 103/104/105, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the ATs 102 over an air interface 115/116/117, which may be any suitable wireless-communication link (e.g., radio frequency (RF), microwave, infrared (IR), ultraviolet (UV), visible light, and the like), and which may be established using any suitable radio access technology (RAT).

More specifically, as noted above, the communications system 100 may be a multiple access system and may employ one or more channel-access schemes, such as CDMA, TDMA, FDMA, OFDMA, SC-FDMA, and the like. For example, the base station 114a in the RAN 103/104/105 and the ATs 102 may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the ATs 102 implement a radio technology such as Evolved UMTS Terrestrial Radio Access (E-UTRA), which may establish the air interface 115/116/117 using LTE and/or LTE-Advanced (LTE-A).

In other embodiments, the base station 114a and the ATs 102a, 102b, and 102c implement one or more radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, as examples, and may utilize any suitable RAT for facilitating wireless connectivity in a localized area, such as a place of business, a home, a vehicle, a campus, and the like. In one embodiment, the base station 114b and the ATs 102c and 102d implement a radio technology such as IEEE 802.11 to establish a wireless local area network (WLAN). In another embodiment, the base station 114b and the ATs 102c and 102d implement a radio technology such as IEEE 802.15 to establish a wireless personal area network (WPAN). In yet another embodiment, the base station 114b and the ATs 102c and 102d utilize a cellular-based RAT (e.g., WCDMA, CDMA2000, GSM, LTE, LTE-A, and the like) to establish a picocell or femtocell. As shown in FIG. 1A, the base station 114b may have a direct connection to the PDN 110. Thus, the base station 114b may not be required to access the PDN 110 via the core network 106/107/109.

The RAN 103/104/105 may be in communication with the core network 106/107/109, which may be any type of network configured to provide voice, data, applications, and/or VoIP services to one or more of the ATs 102. As examples, the core network 106/107/109 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the ATs 102 to access the PSTN 108, the PDN 110, and/or the other networks 112. The PSTN 108 may include circuit-switched telephone networks that provide plain old telephone service (POTS). The PDN (e.g., Internet) 110 may include a global system of interconnected computer networks and devices that use common communication protocols, such as the transmission control protocol (TCP), user datagram protocol (UDP) and IP in the TCP/IP Internet protocol suite. The networks 112 may include wired and/or wireless communications networks owned and/or operated by other service providers, CPs, application providers, and the like. For example, the networks 112 may include another core network connected to one or more RANs, which may employ the same RAT as the RAN 103/104/105 or a different RAT.

Some or all of the ATs 102 in the communications system 100 may include multi-mode capabilities, i.e., the ATs 102 may include multiple transceivers for communicating with different wireless networks over different wireless links. For example, the AT 102c shown in FIG. 1A may be configured to communicate with the base station 114a, which may employ a cellular-based radio technology, and with the base station 114b, which may employ an IEEE 802 radio technology. And certainly other arrangements could be used as well.

FIG. 1B depicts an example access terminal that could be used in connection with at least one embodiment. The AT 102 that is depicted in FIG. 1B could be used in connection with any of the communication systems described herein, including communication system 100 and those described below, as well as with any other communication system deemed suitable by those of skill in the relevant art. As depicted in FIG. 1B, the AT 102 includes a processor 118, a communication interface 119 (that itself includes a transceiver 120), a transmit/receive element 122, a speaker/microphone 124, a keypad 126, a display/touchpad 128, a non-removable memory 130, a removable memory 132, a power source 134, a global positioning system (GPS) chipset 136, and other peripherals 138. It will be appreciated that the AT 102 may include any sub-combination of the foregoing elements while remaining consistent with an embodiment. Also, various different embodiments contemplate that the base stations 114a and 114b, and/or the nodes that base stations 114a and 114b may represent, such as but not limited to a BTS, a Node-B, a site controller, an access point, a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip. Moreover, the communication interface 119 may include one or more other wired-communication (e.g., Ethernet) interfaces and/or one or more additional wireless-communication interfaces.

The transmit/receive element 122 may be configured to transmit signals to, or receive signals from, a base station (e.g., the base station 114a) over the air interface 115/116/117. For example, in one embodiment, the transmit/receive element 122 is or at least includes an antenna configured to transmit and/or receive RF signals. In another embodiment, the transmit/receive element 122 is or at least includes an emitter/detector configured to transmit and/or receive IR, UV, or visible-light signals, as examples. In yet another embodiment, the transmit/receive element 122 is configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the AT 102 may include any number of transmit/receive elements 122. More specifically, the AT 102 may employ MIMO technology. Thus, in one embodiment, the AT 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the AT 102 may have multi-mode capabilities. Thus, the transceiver 120 may include multiple transceivers for enabling AT 102 to communicate via multiple RATs, such as UTRA and IEEE 802.11, as examples.

The processor 118 may be coupled to, and may receive user-input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, processor 118 accesses information from, and stores data in, memory that is not physically located on the AT 102, such as on a server or a home computer (not shown).

The processor 118 may receive power from the power source 134, and may be configured to distribute and/or control the power to the other components of the AT 102. The power source 134 may be any suitable device for powering the AT 102. As examples, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the AT 102. In addition to, or in lieu of, the information from the GPS chipset 136, the AT 102 may receive location information over the air interface 115/116/117 from a base station (e.g., base stations 114a, 114b) and/or determine its location based on the timing of the signals being received from two or more nearby base stations. It will be appreciated that the AT 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, e-compass, satellite transceiver, digital camera (for photographs or video), universal serial bus (USB) port, vibration device, television transceiver, hands-free headset, Bluetooth® module, frequency-modulated (FM) radio unit, digital music player, media player, video-game-player module, an Internet browser, and the like.

FIG. 1C depicts a first exemplary arrangement of the communication system 100 of FIG. 1A, including an example system diagram of the CP 101a (which includes the RAN 103 and the core network 106) according to an embodiment. As noted above, the RAN 103 may employ a UTRA radio technology to communicate with the ATs 102a, 102b, and 102c over the air interface 115. The RAN 103 may also be in communication with the core network 106. As shown in FIG. 1C, the RAN 103 may include Node-Bs 140a, 140b, and 140c, which may each include one or more transceivers for communicating with the ATs 102a, 102b, and 102c over the air interface 115. The Node-Bs 140a, 140b, and 140c may each be associated with a particular cell (not shown) within the RAN 103. The RAN 103 may also include RNCs 142a and 142b. It will be appreciated that the RAN 103 may include any number of Node-Bs and RNCs while remaining consistent with an embodiment.

As shown in FIG. 1C, the Node-Bs 140a and 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-B(s) 140 to which it is connected. In addition, each of the RNCs 142a and 142b may be configured to carry out or support other functionality, such as outer-loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one or more of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the ATs 102a, 102b, and 102c with access to circuit-switched networks, such as the PSTN 108, to facilitate communications between those ATs 102 and traditional landline communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the ATs 102a, 102b, and 102c with access to packet-switched networks, such as the Internet 110, to facilitate communications between those ATs 102 and IP-enabled devices.

As noted above, the core network 106 may also be connected to the other networks 112, which may include other wired and/or wireless networks that are owned and/or operated by other service providers.

FIG. 1D depicts a second exemplary arrangement of the communication system 100 of FIG. 1A, including an example system diagram of the CP 101b (which includes the RAN 104 and the core network 107) according to an embodiment. As noted above, the RAN 104 may employ an E-UTRA radio technology to communicate with the ATs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs while remaining consistent with an embodiment. The eNode-Bs 160a, 160b, and 160c may each include one or more transceivers for communicating with the ATs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the AT 102a.

Each of the eNode-Bs 160a, 160b, and 160c may be associated with a particular cell (not shown) and may be configured to handle radio-resource-management decisions, handover decisions, scheduling of users in the uplink and/or downlink, and the like. As shown in FIG. 1D, the eNode-Bs 160a, 160b, and 160c may communicate with one another over an X2 interface.

The core network 107 shown in FIG. 1D may include a mobility management entity (MME) 162, a serving gateway 164, and a packet data network (PDN) gateway 166. While each of the foregoing elements are depicted as part of the core network 107, it will be appreciated that any one or more of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the ATs 102a, 102b, and 102c, bearer activation/deactivation, selecting a particular serving gateway during an initial attach of the ATs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the ATs 102a, 102b, and 102c. The serving gateway 164 may also perform other functions, such as anchoring user planes during inter-eNode-B handovers, triggering paging when downlink data is available for the ATs 102a, 102b, and 102c, managing and storing contexts of the ATs 102a, 102b, and 102c, and the like.

The serving gateway 164 may also be connected to the PDN gateway 166, which may provide the ATs 102a, 102b, 102c with access to packet-switched networks, such as the PDN 110, to facilitate communications between those ATs 102 and IP-enabled devices.

The core network 107 may facilitate communications with other networks. For example, the core network 107 may provide the ATs 102a, 102b, and 102c with access to circuit-switched networks, such as the PSTN 108, to facilitate communications between those ATs 102 and traditional landline communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the ATs 102a, 102b, and 102c with access to the other networks 112, which may include other wired and/or wireless networks that are owned and/or operated by other service providers.

FIG. 1E depicts a third exemplary arrangement of the communication system 100 of FIG. 1A, including an example system diagram of the CP 101c (which includes the RAN 105 and the core network 109) according to an embodiment. The RAN 105 may be an access service network (ASN) that employs IEEE 802.16 radio technology to communicate with the ATs 102a, 102b, and 102c over the air interface 117. As will be further discussed below, the communication links between the different functional entities of the ATs 102a, 102b, and 102c, the RAN 105, and the core network 109 may be defined as reference points.

As shown in FIG. 1E, the RAN 105 may include base stations 180a, 180b, and 180c, and an ASN gateway 182, though it will be appreciated that the RAN 105 may include any number of base stations and ASN gateways while remaining consistent with an embodiment. The base stations 180a, 180b, and 180c may each be associated with a particular cell (not shown) in the RAN 105 and may each include one or more transceivers for communicating with the ATs 102a, 102b, and 102c over the air interface 117. In one embodiment, the base stations 180a, 180b, and 180c implement MIMO technology. Thus, the base station 180a, for example, may use multiple antennas to transmit wireless signals to, and receive wireless signals from, the AT 102a. The base stations 180a, 180b, and 180c may also provide mobility-management functions, such as handoff triggering, tunnel establishment, radio-resource management, traffic classification, quality-of-service (QoS) policy enforcement, and the like. The ASN gateway 182 may serve as a traffic aggregation point and may be responsible for paging, caching of subscriber profiles, routing to the core network 109, and the like.

The air interface 117 between the ATs 102a, 102b, and 102c and the RAN 105 may be defined as an R1 reference point that implements the IEEE 802.16 specification. In addition, each of the ATs 102a, 102b, and 102c may establish a logical interface (not shown) with the core network 109. The logical interface between the ATs 102a, 102b, and 102c and the core network 109 may be defined as an R2 reference point (not shown), which may be used for authentication, authorization, IP-host-configuration management, and/or mobility management, and/or the like.

The communication link between each of the base stations 180a, 180b, and 180c may be defined as an R8 reference point that includes protocols for facilitating AT handovers and the transfer of data between base stations. The communication link between the base stations 180a, 180b, and 180c and the ASN gateway 182 may be defined as an R6 reference point. The R6 reference point may include protocols for facilitating mobility management based on mobility events associated with each of the ATs 102a, 102b, and 102c.

As shown in FIG. 1E, the RAN 105 may be connected to the core network 109. The communication link between the RAN 105 and the core network 109 may defined as an R3 reference point that includes protocols for facilitating data transfer and mobility-management capabilities, as examples. The core network 109 may include a mobile-IP home agent (MIP-HA) 184, an authentication, authorization, accounting (AAA) server 186, and a gateway 188. While each of the foregoing elements are depicted as part of the core network 109, it will be appreciated that any one or more of these elements may be owned and/or operated by an entity other than the core network operator.

The MIP-HA 184 may be responsible for IP-address management, and may enable the ATs 102a, 102b, and 102c to roam between different ASNs and/or different core networks. The MIP-HA 184 may provide the ATs 102a, 102b, and 102c with access to packet-switched networks, such as the PDN 110, to facilitate communications between those ATs 102 and IP-enabled devices. The AAA server 186 may be responsible for user authentication and for supporting user services. The gateway 188 may facilitate interworking with other networks. For example, the gateway 188 may provide the ATs 102a, 102b, and 102c with access to circuit-switched networks, such as the PSTN 108, to facilitate communications between those ATs 102 and traditional landline communications devices. In addition, the gateway 188 may provide the ATs 102a, 102b, and 102c with access to the other networks 112, which may include other wired and/or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point (not shown), which may include protocols for coordinating the mobility of the ATs 102a, 102b, and 102c between the RAN 105 and the other ASNs. The communication link between the core network 109 and the other core networks may be defined as an R5 reference point (not shown), which may include protocols for facilitating interworking between home core networks and visited core networks.

FIG. 1F depicts a second exemplary communication system in which at least one embodiment can be implemented. In particular, FIG. 1F depicts a communication system 190 that includes the PDN 110 of FIG. 1A connected by a communication link 191 to a CP 192, which in turn is connected by a communication link 193a to a network access device 194a, and also by a communication link 193b to a network access device 194b. The network access device 194a is connected by a communication link 195a to an AT 102e, which as depicted in this embodiment is a desktop computer. The network access device 194b is connected via a communication link 195b to a router 196, which in turn is connected (i) by a wireless (e.g., Wi-Fi) communication link 197f to an AT 102f, which as depicted in this embodiment is a tablet (i.e., a tablet computer), (ii) by a wireless (e.g., Wi-Fi) communication link 197g to an AT 102g, which as depicted in this embodiment is a smartphone, (iii) by a wireless (e.g., Wi-Fi) communication link 197h to an AT 102h, which as depicted in this embodiment is a cell phone, and (iv) by a wired (e.g., Ethernet) communication link 197i to an AT 102i, which as depicted in this embodiment is a laptop computer.

In at least one embodiment, CP 102 provides cable-modem service, and each of network access device 194a and network access device 194b are cable modems. In at least one embodiment, CP 102 provides DSL service, and each of network access device 194a and network access device 194b are DSL modems. And certainly many other examples could be listed as known by those of skill in the relevant art. Moreover, any one or more of the depicted communication links could include one or more wired-communication segments and/or one or more wireless-communication segments. And certainly more than two network access devices could be depicted, as two are shown by way of example and not limitation. Furthermore, the communication system 190 of FIG. 1F is intentionally depicting only a single CP (i.e., CP 192), though it is contemplated that one or more CPs could be present as well in the communication system 190, where one or more of such additional CPs could provide data-connectivity service via respective network access devices to the site of AT 102e and/or to the site of ATs 102f-102i.

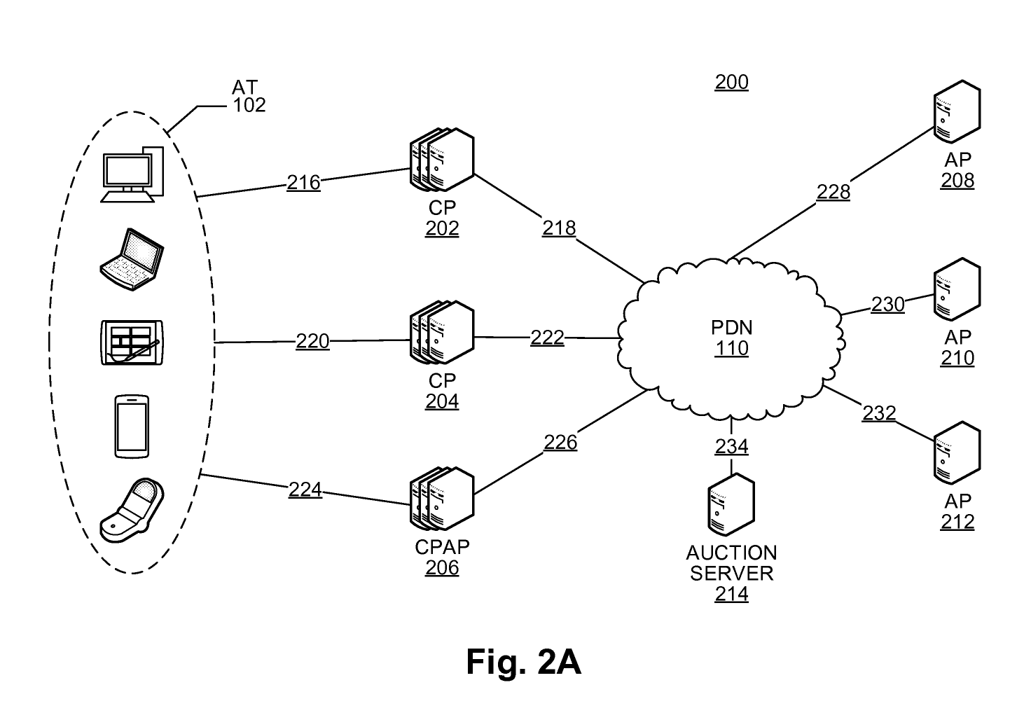

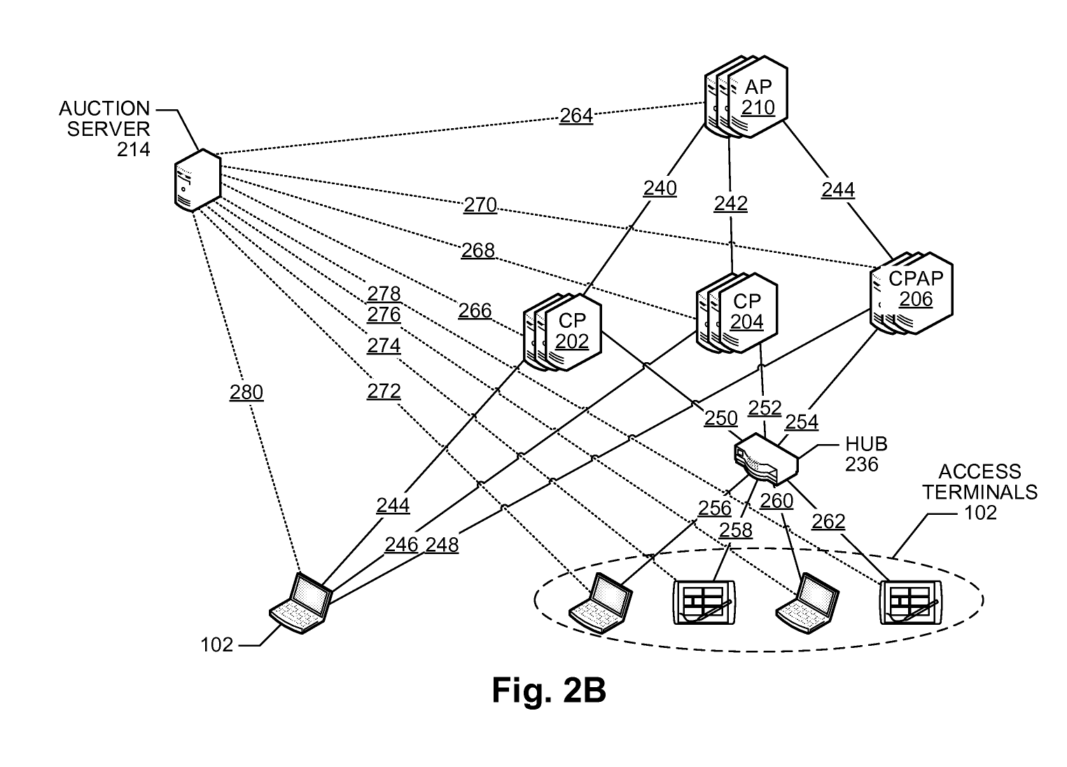

FIG. 2A depicts a first view of a third exemplary communication system in which at least one embodiment can be implemented. In particular, FIG. 2A depicts a communication system 200 that includes three different CPs 202, 204, and 206, though any number could be present in various different implementations and contexts. The CP 202 provides ATs 102 access to the PDN 110 via the communication links 216 and 218. The CP 204 provides ATs 102 access to the PDN 110 via the communication links 220 and 222. And CP 206, which in this example embodiment is also an application provider (abbreviated “AP,” thus “CPAP 206”) in FIG. 2A, illustrating that a single business or other organization may operate a network that provides both connectivity and application-specific data services to various ATs 102, provides ATs access to the PDN 110 via the links 224 and 226. Any of the links shown in FIG. 2A could include one or more wired-communication (e.g., Ethernet) segments and/or one or more wireless-communication (e.g., LTE, Wi-Fi, etc.) segments.

Also depicted in the embodiment shown in FIG. 2A is an AP 208 connected via a communication link 228 to the PDN 110, an AP 201 connected via a communication link 230 to the PDN 110, an AP 212 connected via a communication link 232 to the PDN 110, and an auction server 214 connected via a communication link 234 to the PDN 110. In the example embodiment depicted in FIG. 2A, individual ATs 102 and/or groups of ATs 102 have the options of choosing to buy data-connectivity service from CP 202, CP 204, or CPAP 206. Moreover, in the depicted embodiment, the APs (i.e., CPAP 206, AP 208, AP 210, and AP 212) provide directly competing application service, and thus individual ATs 102 and/or groups of ATs 102 have the options of choosing to buy this application service from data-connectivity service from CP 202, CP 204, or CPAP 206.

FIG. 2B depicts a second view of the communication system 200 of FIG. 2A. In particular, FIG. 2B depicts both some logical (e.g., account-based) connections and some physical communication paths between and among some of the various entities that are depicted in FIG. 2A. As shown in FIG. 2B a single laptop computer AT 102 has a logical connection (e.g., has a user account with a login and password) 280 with the auction server 214. Also having similar logical connections 272, 274, 276, and 278, respectively, are the four ATs 102 shown within the dashed oval in FIG. 2B.

Moreover, auction server 214 is depicted as having a logical connection 266 with CP 202, a logical connection 268 with CP 204, and a logical connection 270 with CPAP 206. In at least one embodiment, these logical connections 266, 268, and 270 (which may also be account-based, though accounts of a different type (CP) than are associated with each AT 102) relate to auction server 214 including CP 202, CP 204, and/or CPAP 206 (in its capacity as a CP) as candidate sellers of data-connectivity service in one or more reverse auctions, as described herein. Furthermore, auction server 214 also has a logical connection 264 with AP 210. (It is noted that AP 208 and AP 212 could be present in FIG. 2B as well, but were intentionally omitted for clarity of presentation and not by way of limitation.)

In at least one embodiment, the logical connections 264 and 270 (which may also be account-based, though accounts of a different type (AP) than are associated with each AT 102) relate to auction server 214 including CPAP 206 (in its capacity as an AP) and AP 210 as candidate sellers of application service in one or more reverse auctions, as described herein. As such, any of the logical, account-based associations described herein may include any necessary contact information, validation information, certification information, payment information, verification information, authentication information, and/or one or more of any other types of information deemed suitable by those of skill in the art for a given context.

Moreover, FIG. 2B also depicts the single laptop computer AT 102 as having connectivity to and via the CP 202 via a communication link 244 and in turn to the AP 210 via a communication link 240. By viewing FIG. 2B with FIG. 2A, it can be appreciated that, as examples, the communication link 248 may be or include the communication link 216, and that the communication link 240 may be or include the communication link 218, the PDN 110, and the communication link 230. And similar relationships between the communication links depicted in FIG. 2B and the communication links depicted in FIG. 2A will be apparent to those having ordinary skill in the relevant art. The single laptop computer AT 102 also has connectivity to and via the CP 204 via a communication link 246 and in turn to the AP 210 via a communication link 242, as well as connectivity to and via the CPAP 206 via a communication link 248 and in turn to the AP 210 via a communication link 244.

Additionally, the four ATs 102 within the dashed oval in FIG. 2B are connected to a hub 236 by respective communication links 256, 258, 260, and 262. The hub 236, in turn, is connected to the CP 202 via a communication link 250, to the CP 204 via a communication link 252, and to the CPAP 206 via a communication link 254. In at least one embodiment, the hub 236 and the four associated ATs 102 in FIG. 2B may be arranged and connected in a manner similar to that of (i) the combination of network access device 194b and the router 196 and (ii) the ATs 102f, 102g, 102h, and 102i of FIG. 1F. Continuing that comparison, the hub 236 may be connected to the various CPs 202, 204, and 206 in a manner similar to the way that the network access device 194b is connected via the communication link 193b to the CP 192 in FIG. 1F. And certainly other example configurations are possible.

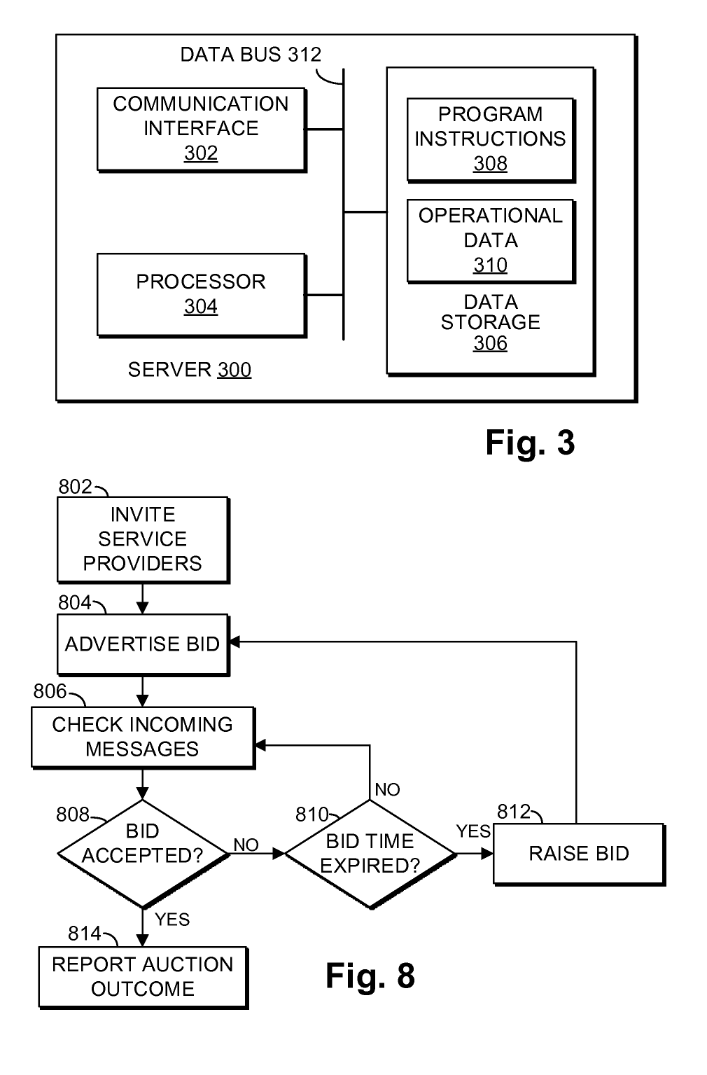

FIG. 3 depicts an exemplary server that could be used in connection with at least one embodiment. In particular, FIG. 3 depicts a server 300, which could represent a single server or a group of servers in various different embodiments. The structure and arrangement shown and described in connection with the example server 300 could in various embodiments be the structure and arrangement of entities such as CP 101a/101b/101c, RAN 103/104/105, core network 106/107/109, base station 114a, base station 114b, Node-B 140a, Node-B 140b, Node-B 140c, RNC 142a, RNC 142b, MGW 144, MSC 146, SGSN 148, GGSN 150, eNode-B 160a, eNode-B 160b, eNode-B 160c, MME 162, serving gateway 164, PDN gateway 166, base station 180a, base station 180b, base station 180c, ASN gateway 182, MIP-HA 184, AAA 186, gateway 188, CP 192, network access device 194a, network access device 194b, router 196, CP 202, CP 204, CPAP 206, AP 208, AP 210, AP 212, auction server 214, hub 236, and/or one or more other entities deemed suitable for inclusion by those of skill in the relevant art in a given implementation or particular context.

As shown in FIG. 3, the server 300 includes a communication interface 302, a processor 304, and non-transitory data storage 306, all of which are communicatively linked by a bus, network, or other communication path 312.

Communication interface 302 may include one or more wired communication interfaces and/or one or more wireless-communication interfaces. With respect to wired communication, communication interface 302 may include one or more interfaces such as Ethernet interfaces, as an example. With respect to wireless communication, communication interface 302 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 302 may be equipped at a scale and with a configuration appropriate for acting on the network side or the client side of wireless communications (e.g., LTE communications, Wi-Fi communications, and the like). With respect to network-side (i.e. server-side) configurations, communication interface 302 may include the appropriate equipment and circuitry (perhaps including multiple transceivers) for serving multiple mobile stations, UEs, or other access terminals in a coverage area.

Processor 304 may include one or more processors of any type deemed suitable by those of skill in the relevant art, some examples including a general-purpose microprocessor and a dedicated DSP. Data storage 306 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 1F, data storage 306 contains program instructions 308 executable by processor 304 for carrying out various combinations of the various server (or other network-entity) functions described herein, and further contains operational data 310, which may include any data necessary or advantageous to the carrying out of such functions.

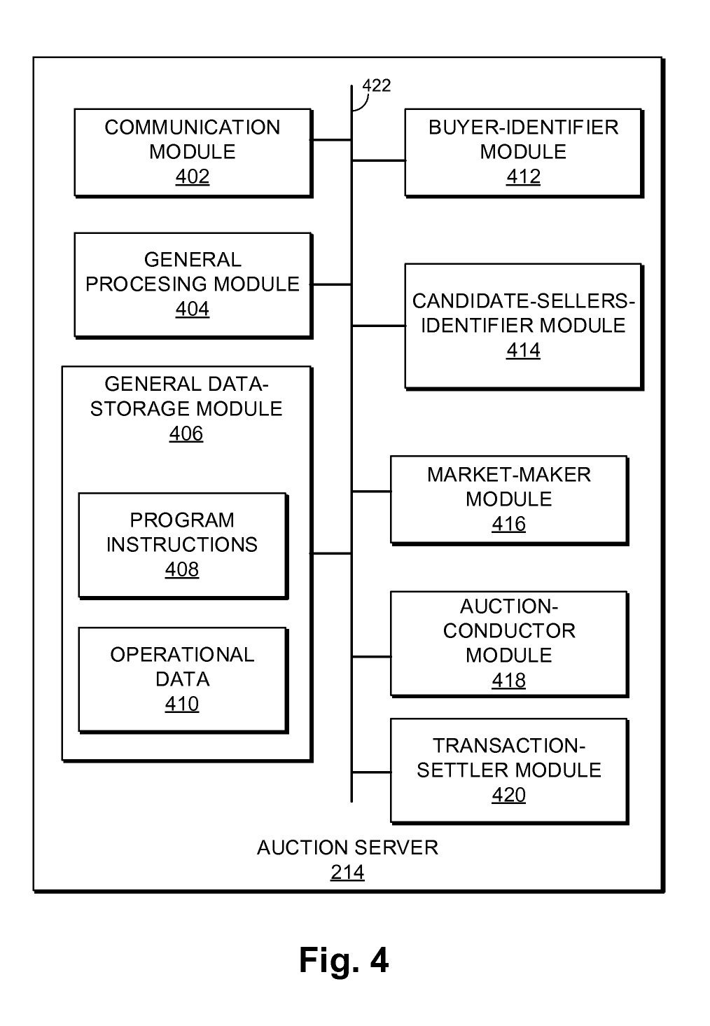

FIG. 4 depicts an exemplary auction server in accordance with at least one embodiment. In particular, FIG. 4 depicts auction server 214 as including a communication module 402, a general processing module 404, a general data-storage module 406 (containing program instructions 408 and operational data 410), a buyer-identifier module 412, a candidate-sellers-identifier module 414, a market-maker module 416, an auction-conductor module 418, and a transaction-settler module 420, all of which are communicatively linked by a data bus, network, and/or other suitable connection mechanism 422. It is noted that the term module includes any necessary hardware and any necessary executable instructions (be they stored as hardware, firmware, and/or software) stored in non-transitory data storage for carrying out at least the functions described in connection with a given module.

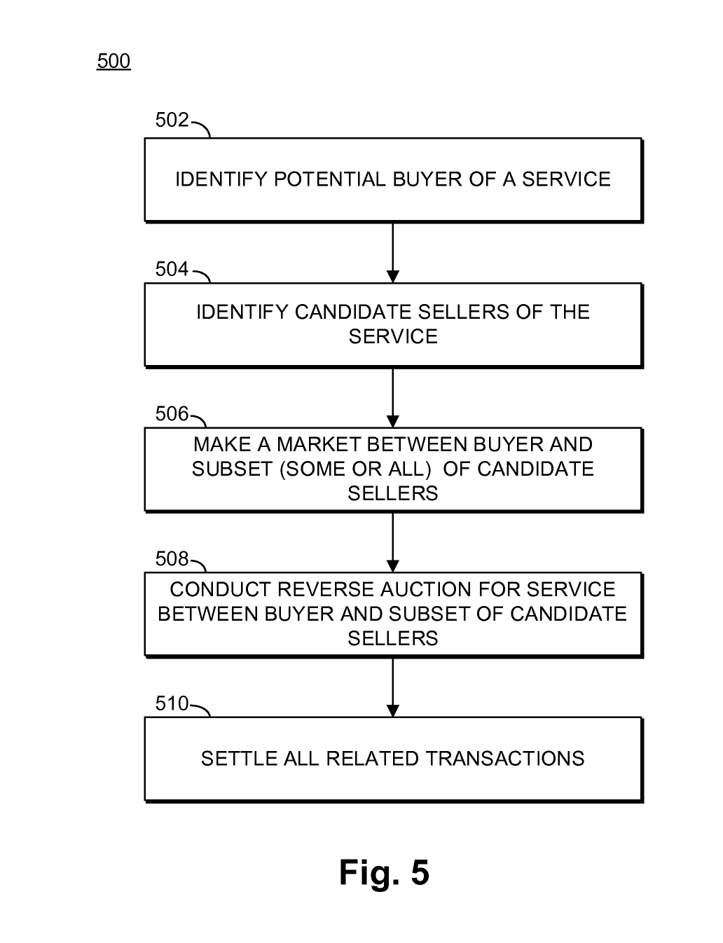

In at least one embodiment, the communication module 402, the general processing module 404, the general data-storage module 406, the program instructions 408, and the operational data 410 may respectively take the form of the communication interface 302, the processor 304, the non-transitory data storage 306, the program instructions 308, and the operational data 310 that are described above in connection with FIG. 3, and thus are not described in detail here. In the context of FIG. 4, it is noted that: (i) the functions described in connection with buyer-identifier module 412 include those described below in connection with step 502 of FIG. 5, (ii) the functions described in connection with candidate-sellers-identifier module 414 include those described below in connection with step 504 of FIG. 5, (iii) the functions described in connection with market-maker module 416 include those described below in connection with step 506 of FIG. 5, (iv) the functions described in connection with auction-conductor module 418 include those described below in connection with step 508 of FIG. 5, and (v) the functions described in connection with a transaction-settler module 420 include those described below in connection with step 510 of FIG. 5.

FIG. 5 depicts an exemplary method in accordance with at least one embodiment. In particular, FIG. 5 depicts a method 500 that in at least one embodiment is carried out by auction server 214, and that in other embodiments can be carried out alone or in combination by one or more of any of the network entities described herein and/or one or more of any other type of network entity deemed suitable by those of skill in the relevant art for a given implementation or a particular context.

Step 502 involves the auction server 214 identifying a potential buyer of a service, where the potential buyer is a participant in a networked application (e.g., a multi-player networked game). In at least one embodiment, the service is an application service. In at least one embodiment, the service is a connectivity service. In at least one embodiment, the candidate sellers are application providers. In at least one embodiment, the candidate sellers are connectivity providers.

In at least one embodiment, identifying the potential buyer of the service involves determining at least a state of the networked application, and further involves identifying the service based at least in part on the determined state of the networked application. In at least one such embodiment, the determined state of the networked application includes an end-to-end state of the networked application. In at least another such embodiment, the determined state of the networked application includes a state of an application server providing the networked application. In at least another such embodiment, the determined state of the networked application includes a state of at least one network via which the networked application is being provided. In at least another such embodiment, the determined state of the networked application includes a state of at least one current user of the networked application, the at least one current user including the potential buyer. In at least one such embodiment, the state of the buyer includes one or more of a user profile corresponding to the potential buyer, a type of equipment in use by the potential buyer in connection with the networked application, a type of data connection in use by the potential buyer in connection with the networked application, a connection speed in use by the potential buyer in connection with the networked application, and a location of the potential buyer. In at least another such embodiment, the determined state of the networked application includes at least one of packet-delay data, packet-loss data, and jitter data.

Step 504 involves the auction server 214 identifying candidate sellers of the service for which a potential buyer was identified in step 502.

In an embodiment, this step involves identifying those local (to the potential buyer) service providers who are within a certain geographic range of the potential buyer's present location, such as 30 miles for instance. In an embodiment, auction server 214 uses real-time service availability data as well as projection algorithms to assist in identifying candidate sellers. By incorporating such approaches, the auction server in some cases would eliminate from consideration one or more service providers determined to be unable to supply the needed service to the potential buyer. In at least one embodiment, the auction server 214 eliminates from consideration one or more candidate sellers having poor recent feedback ratings, a history of bill disputes, and/or one or more other similar characteristics.

Step 506 involves the auction server 214 making a market between the potential buyer identified in step 502 and a subset (including some or all) of the candidate sellers identified in step 504.

In at least one embodiment, making the market between the identified potential buyer and the subset of the identified candidate sellers involves notifying each of the identified candidate sellers of their respective invitation to participate in the reverse auction, and further involves including in the subset any identified candidate seller from which an acceptance of the corresponding invitation is received. In at least one such embodiment, notifying each of the identified candidate sellers of their respective invitation to participate in the reverse auction involves notifying each of the identified candidate sellers of one or more of an initial price for bids, state information regarding the networked application, and information defining the service.

In at least one embodiment, making the market between the identified potential buyer and the subset of the identified candidate sellers involves charging an auction-participation fee to each identified candidate seller in the subset.

In at least one embodiment, the subset of identified candidate sellers includes some but not all of the identified candidate sellers. In at least one embodiment, the subset of identified candidate sellers includes all of the identified candidate sellers.

Step 508 involves the auction server 214 conducting a reverse auction for the service for which a potential buyer was identified in step 502 between (i) the potential buyer identified in step 502 and (ii) the subset of candidate sellers identified in step 504 for which a market was made in step 506. This step may involve real-time and/or near real-time implementations of online reverse auctions, enabling candidate sellers to place bids, see a current best bid, place new bids, and the like, as well as computing and displaying time duration of a current auction, and the like, and in various embodiments using real-time data-management so as to reliably relay bid prices among auction participants. And certainly other reverse-auction aspects could be listed by way of example.

In at least one embodiment, the reverse auction is an English reverse auction. In English reverse auctions, the starting bid is the highest price the potential buyer is willing pay for the service, and subsequent prices are lowered. In such auctions, bidders compete with one another for a predefined period of time or until a pre-defined bid is reached.

In at least one embodiment, the reverse auction is a Dutch reverse auction. In Dutch reverse auctions, the starting price set by the auction server 214 is low and subsequent prices are increased until an auction participant (i.e., a candidate seller) agrees to sell the particular service for that price. In some instances, Dutch reverse auctions may be concluded by the submission of a first bid. For example, in a Dutch reverse auction the auction server 214 might announce a set price (often low) to the candidate sellers, and the first candidate seller (i.e., service provider) to respond may win the business. In this case and in all cases, the auction server 214 implements reliable and timely communication regarding bidding information. In some embodiments that involve Dutch reverse auctions, competing candidate sellers are not made aware of one another's bids. In a sense, then, such embodiments resemble a system whereby a “yes or no” proposition is put to each candidate seller, and whereby the first such candidate seller to respond in the affirmative is the winning seller for that particular Dutch reverse auction. The other (non-winning) participants could then be notified that the reverse auction has concluded. In some embodiments involving a Dutch reverse auction, the bidding process is closed upon receipt from any candidate seller of an acceptance of a given selling price.

In some embodiments, candidate sellers are prioritized, in some cases into tiers of varying priorities, where higher-priority sellers are given more frequent and perhaps earlier opportunities to participate in various reverse auctions. Such priority could be awarded based on payment for such priority, based on positive feedback in previous reverse auctions, based on winning (or losing) previous reverse auctions, and/or based on one or more other factors deemed suitable by those having skill in the relevant art for a given implementation.

Step 510 involves the auction server 214 settling all related transactions. In at least one embodiment, settling all related transactions includes the buyer remitting an auction fee to the auction server. In at least one embodiment, settling all related transactions includes the buyer remitting a service fee to the selected winning seller. In at least one embodiment, settling all related transactions involves performing auction settlement with the selected winning seller. In at least one embodiment, settling all related transactions involves finalizing a service contract that binds the selected winning seller to provide the service to the buyer according to terms agreed to by both the selected winning seller and the buyer. In at least one embodiment, settling all related transactions involves transmitting a work order for the service to the selected winning seller. In at least one embodiment, settling all related transactions involves carrying out a billing function. In at least one embodiment, settling all related transactions involves carrying out billing and reconciliation functions. In at least one embodiment, settling all related transactions involves conducting dispute resolution.

In at least one embodiment, the auction server provides a feedback-receiving function that involves storing at least one received feedback message. In at least one such embodiment, the auction server also provides at least the at least one received feedback message to a participant in a later reverse auction.

In at least one embodiment, the winning seller provides the purchased service to the buyer.

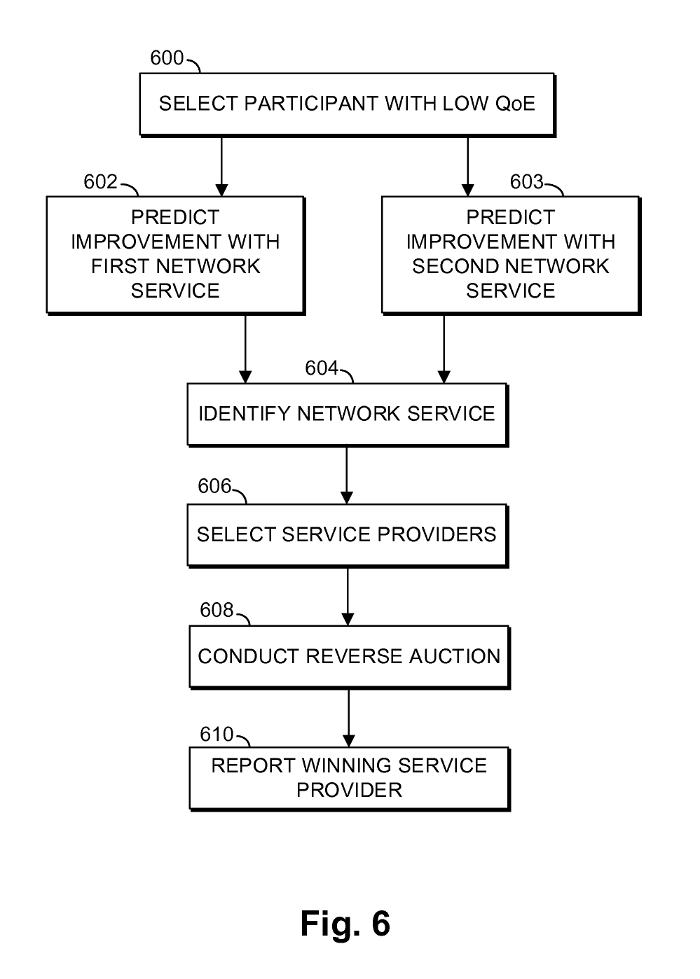

FIG. 6 illustrates a method employed by an auction server in some embodiments. In step 600, the auction server identifies a participant in a networked application with a low quality of experience (QoE). The networked application may be a multi-player networked game. As described above with respect to step 502 of FIG. 5, selection of a user with low QoE may be based on the state of the networked application, which can include such information as packet-delay data, packet-loss data, and jitter data. For example, the auction server may receive information identifying the latency in respective participants' user of the networked application. This information may be received from the participants directly or may be received from or through the application servers. The latency information may be, for example, an average transit time for packets sent to the participant from the application server used by the participant. The average may be a running weighted average. The auction server may determine that a participant has a low quality of experience if the latency for that participant is above a threshold latency. Alternatively, the latency may be one factor among others in a calculation of the participant's quality of experience.

In some embodiments, the selection of a participant with a low quality of experience may include selecting a participant who is experiencing a high latency jitter. For example, the auction server may receive from participants information identifying the latency jitter in the respective participants' use of the networked application. This information may be sent to the auction server directly by the participants or it may be sent from or through the participants' respective application servers. The auction server may determine that a participant has a low quality of experience if the latency jitter for that participant is above a threshold latency jitter. Alternatively, the latency jitter may be one factor among others in a calculation of the participant's quality of experience.

In steps 602-604, the auction server determines the specific service or capability to be auctioned. In some embodiments, the determination of the service to be auctioned includes applying inference rules that specify what service capabilities are needed in order to remedy a particular performance problem or provide a needed functionality for the participant with a low QoE. In some embodiments, this involves comparing predicted QoE improvements for different available network services. For example, in step 602, the auction server determines a predicted improvement from using a first network service, and in step 603, the auction server determines a predicted improvement from using a second network service. In step 604, the auction server determines which of the two (or more) network services would provide the greatest improvement of QoE. For example, when a user is connected to a particular application provider and is experiencing a low QoE, the auction server may determine whether a greater QoE improvement would be achieved by (1) switching the user to a different application provider or (2) switching the user to a different connectivity provider.

The auction server may determine what service to auction based on predetermined rules. In some embodiments, the auction server may determine what service to auction based on inference rules. Rules may take the form of a list of conditions under which an auction is to be initiated or a logical statement that, when evaluated as true, leads to the initiation of an auction. Such conditions or logical statements may be stored in a table or database and can be linked or otherwise associated with the type of auction to be conducted.

One example of a rule is as follows: if a user is playing a game that requires latency value below X, jitter value below Y, and computing power characteristics with a value above W, and if the current values of these parameters as indicated by the information provided from the network do not comply with the requirements, then initiate an auction to remedy the insufficient resource situation. The logical “if” part of the rule represents the situation and the “then” part represents the action to be taken if the situation arises. In order to determine if the “if” part of the rule holds true, the auction server acquires information as to which game the user is playing and stores information associated with the game that specifies the game's resource requirements. Once the auction server determines from the real-time data it receives that the particular game does not have sufficient resources for adequate quality of experience, the auction server may initiate an auction for the user in order to obtain the resource. The specific information about the game requirements, as well as the ability to enter specific rules is provided by the auction server through an administrative interface to a human operator or through an application program interface to data that contains this information on other computers. The attributes of the games and the service (such as jitter, delays and computing power) can be represented in a variety of ways, for example as attribute-value pairs.

In some embodiments, if the conditions for conducting an auction are met, the auction server offers the user the option of whether or not to conduct the auction. For example, a pop-up window may appear for the user inquiring whether an auction should be conducted to improve the user's quality of experience. Alternatively, such communications may be made through other channels, such as email or text messaging. By providing users with this option, users with a satisfactory quality of experience can decline to pay for higher levels of service. In some embodiments, the auction server tracks measured parameters (such as latency and jitter) and compares those parameters with user responses to prepare or refine a statistical estimate of the network conditions under which users are willing to purchase enhanced network services. These statistical estimates can in turn be used to refine the rules for initiating auctions.

The determination of whether or not to require user approval before conducting a particular auction can be made in various ways. For example, the auction server may be configured to require approval only from specified users, based for example on a user preference. In some embodiments, the determination may be set at different levels of service. For example, some levels of service may offer higher levels of configurability (e.g., configurability as to whether to seek user approval before beginning an auction). Configuration can be performed through a web page or through another method, such as email or text messaging. The rules and policies that are configurable by a user may be determined when the user subscribes to an auction service, and the user may be given the opportunity at a later time to change the configurations.

In some embodiments, the auction server may determine that an auction is required is if it receives information from other sources indicating that the user's quality of experience is not adequate. Such other sources could be other decision engines in other services that the user is engaged with that will request the additional resources based on their own rules.

In some embodiments, instead of determining which service out of a plurality of services would provide the greatest improvement, the auction server determines whether a particular service is predicted to provide a quality of service improvement. In response to that determination, the auction server can conduct an auction among providers of the service.

In some embodiments, the auction sever identifies a network service to be auctioned by determining the actual state of the networked application and using that information to determine the state that the application would be predicted to have if a first network service were implemented. The server then calculates a predicted quality of experience with the first network service. This process may be repeated to determine a predicted quality of experience improvement for other network services (a second service, third service, etc.), allowing the auction server to determine which service would result in the greatest quality of experience improvement. The auction server may use this technique to distinguish between, for example, an application service and a connectivity service.

The determination of QoE improvement may take into consideration an estimated cost of the network service. For example, a costly network service that is estimated to provide a large reduction in latency may be less favorable from the QoE perspective than a cheaper network service that provides a slightly more modest reduction in latency. Cost estimates may be based on historical information (e.g. an average) of the outcome of past auctions, possibly taking into consideration the time of day, day of the week, or other information that may influence the estimated cost of the network service.

In step 606, the auction server selects service providers capable of providing the selected service. For example, when the auction server has decided to conduct an auction for an application service, the auction service may select a plurality of service providers located within a predetermined geographic range of the selected participant. When the auction server has decided to conduct an auction for a connectivity service, the auction server may select a plurality of connectivity service providers that are capable of providing connectivity between the selected participant and an application service used by the selected participant. The auction server may restrict its selection only to those network services that have received sufficiently positive feedback. The auction server may select less than all available service providers, for example by selecting a random subset of available service providers, or by weighting an otherwise random selection in favor of service providers who have received sufficiently positive feedback from participants.

The option to participate in an auction can be presented to the user, or the auction can be initiated automatically based on pre-defined policies. The auction server may launch an auction without notifying the user at all if such a policy was specified. Alternatively, the auction server can communicate with the user to request approval for an auction. This communication can be accomplished in a variety of ways such as a pop up window on the screen or a text message or a Twitter message, for example.

The user may be notified in real time that a decision regarding launching an auction is needed to be made and asked if he would like to make it. If the user chooses not to participate in the decision, then the auction servers makes the decision automatically based on pre-defined guidelines that were provided by the user regarding cost and circumstances under which the auction should go forward (e.g., whether this time of day historically problematic in terms of available bandwidths). Alternatively, if the user choses to be part of the decision as to whether to conduct an auction, or if the user has set a policy to always be part of the decision on whether or not to start the auction, the options are communicated to the user.

In a case where the user is involved in the decision of whether to conduct an auction, the user may be presented with information associated with the current state of the resources and the suggested level of resources needed for the game. The user may be also provided with other game-related information, such as the length of time over which the resources are needed for the game, the possible cost of the auctioned resources, and/or statistics about other users known to the auction server that are also suffering from the same resource issues. The user may also be given some available statistics about the resource issues (e.g., delays) based on historic data for the time of day, day of week and the location.

The auction of network resources may be employed not only in the playing of online games, but also in other situations where greater network resources can lead to a greater quality of experience. For example, an auction can be held where a user is planning to watch a movie on line (e.g., streaming from Netflix or Amazon) or is already watching a movie, as well as when the user is engages with other networked, resource intensive applications.

The auction option may be offered to the user at any time. The policy on whether or not the option is presented and in what form (e.g., whether the option is merely a notification that a decision needs to be made, or whether the option is presented with the full information needed for the decision) may be predefined by the user or by the auction server. Similarly, information can be stored regarding when, in an online game or other media session, an auction notification can be presented. For example, the auction server may store information identifying predefined portions of a game at which the option of participating an auction can be presented. The portions of a game or game conditions under which an auction can occur can be configured by a user.

If an auction is about to take place, the user's participation in a networked game may or may not be affected. The user may choose to “lay low” during the auction period until more network resources are available, or he may choose to alter his play in other ways or to pause the game altogether on his end. In some embodiments, the auction server provides an instruction to the game server to slow down the game or pause it automatically for the affected user. The game may also be slowed down or paused for other players in the same area of the game.

Once the participant and the service providers have been selected, the auction server in step 608 conducts a reverse auction in which the service providers compete for the opportunity to provide the selected service to the participant. When the auction is concluded, the auction server in step 610 reports the winning service provider to the participant, to the winning service provider, and/or to the participant's current service provider as required to effect a transfer of the participant to the winning service provider. As described above with respect to step 510, the auction server may further provide settlement services for the auction.

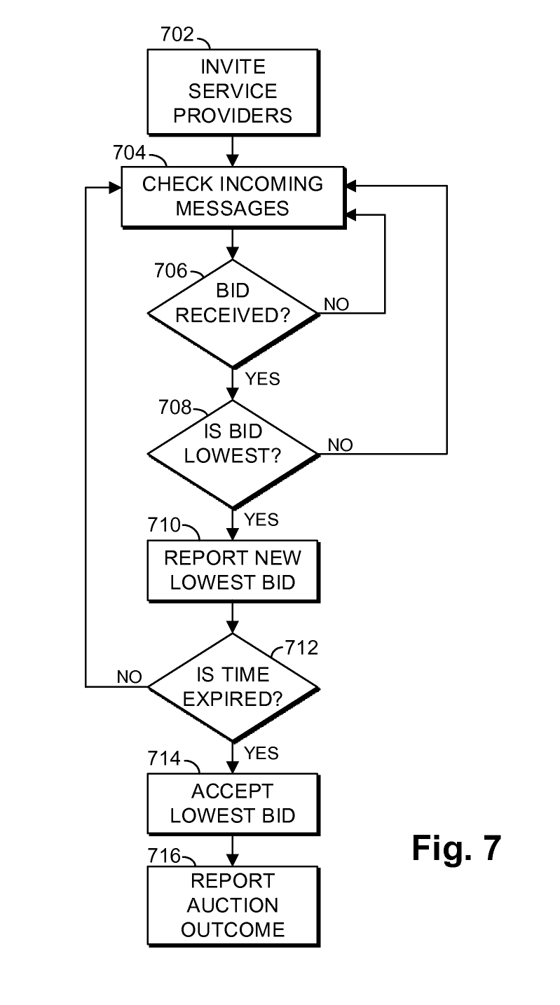

The reverse auction may be conducted as a reverse English auction. In one such embodiment, illustrated in FIG. 7, the auction server in step 702 invites the selected service providers to participate in the reverse auction. The invitation may be conducted through a message identifying the service to be provided. The invitation may also identify the participant for whom the service is to be provided. In an embodiment in which the service is intended to replace a current service employed by the participant, the invitation may identify the provider of the current service.

In step 704, the auction server checks incoming messages for bids from service providers. The bids may be messages that include a specific price, or the bids may be messages accepting a proposed bid advertised by the auction server. The auction identifies the lowest bids from among received bids. For example when the auction server determines that a bid has been received (step 706), it determines in step 708 whether the received bid is the lowest bid received thus far. The auction server may then report the lowest bid in step 710 (e.g. through messages sent to the service providers), allowing other service providers the opportunity to undercut the reported bid. The message reporting a bid may be implemented by a message soliciting a lower bid. For example, a message from the auction server that solicits a bid at a certain price may be understood as reporting that a bid incrementally higher than that price has been submitted. After a time limit for bids has expired (step 712), the auction server accepts the lowest bid (step 714) and reports the outcome of the auction (step 716), at least to the winning service provider.

In some embodiments, the auction may be conducted as a reverse Dutch auction. In one such embodiment, illustrated in FIG. 8, the selected service providers are invited in step 802 to participate in the auction. In step 804, the auction server advertises a low opening bid, e.g. through messages sent to the selected service providers. In step 806, the auction server 806 monitors incoming messages for acceptance of the advertised opening bid. A sequence of increasing bid prices is provided, with bids being raised incrementally after a predetermined amount of time. Thus, if the advertised bid has not been accepted (step 808), then once a predetermined amount of time has passed (step 810) the auction server incrementally raises the advertised bid in step 812. The process repeats, with the price being raised incrementally until a bid is accepted by a service provider (step 808). In step 814, the auction server reports the outcome of the auction at least to the winning service provider.

Preferably, the auction server may operate to prevent the advertised bid from rising above a maximum price. The maximum price may be set using, for example, stored user preferences of the participant, or the participant may agree to a maximum price before the initiation of the auction.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in any device.

1. A method comprising:
selecting, from among a plurality of participants in networked application, a participant with a low quality of experience;
identifying a type of network service from among two or more types of network services that is predicted to improve the participant's quality of experience;
selecting a plurality of service providers capable of providing the identified type of network service; and
conducting a reverse auction between the selected participant and the selected plurality of service providers for the identified type of network service.

2. The method of claim 1, wherein the networked application is a multi-player networked game.

3. The method of claim 1, wherein selecting a participant includes:
receiving, from a plurality of participants, information identifying latency in the respective participants' use of the networked application; and
selecting a participant with a latency above a threshold latency.

4. The method of claim 1, wherein selecting a participant includes:
receiving, from a plurality of participants, information identifying latency jitter in the respective participants' use of the networked application; and
selecting a participant with a latency jitter above a threshold latency jitter.

5. The method of claim 1, wherein identifying a type of network service includes:
determining an actual state of the networked application;
determining a predicted state of the networked application using at least a first type of network service; and
calculating a predicted quality of experience improvement with the use of the first type of network service.

6. The method of claim 1, wherein identifying a type of network service includes identifying a type of service from the group consisting of an application service and a connectivity service.

7. The method of claim 1, wherein the identified type of network service is an application service, and wherein selecting a plurality of service providers includes selecting application service providers within a predetermined geographic range of the selected participant.

8. The method of claim 1, wherein the identified type of network service is a connectivity service, and wherein selecting a plurality of service providers includes selecting connectivity service providers capable of providing connectivity between the selected participant and an application service used by the selected participant.

9. The method of claim 1, wherein the reverse auction is an English reverse auction, and wherein conducting the reverse auction includes:
sending, to the selected plurality of service providers, information identifying the type of network service;
receiving at least one bid from the selected plurality of service providers;
identifying a lowest bid from among the received bids; and
informing a service provider associated with the lowest bid that it has won the auction.

10. The method of claim 1, wherein the reverse auction is a Dutch reverse auction, and wherein conducting the reverse auction includes:
sending, to the selected plurality of service providers, information identifying the type of network service;
sending, to the selected plurality of service provides, information identifying a sequence of increasing bid prices;
receiving an acceptance of at least one of the bid prices from an accepting one of the plurality of service providers; and
informing the accepting service provider that it has won the auction.

11. A method comprising:
determining at least one service parameter representing an quality of experience of a participant in a networked application;
predicting an amount by which a first type of network service would improve the service parameter;
predicting an amount by which a second type of network service would improve the service parameter;
in response to a prediction that the first type of network service will improve the service parameter, and only after determining that the first type of network service would improve the service parameter more than the second type of network service:
selecting a plurality of service providers capable of providing the first type of network service; and
conducting a reverse auction between the participant and the selected plurality of service providers for the first type of network service.

12. (canceled)

13. The method of claim 11, wherein one of the first and second type of network services is an application service and the other of the first and second type of network services is a connectivity service.

14. An auction server comprising a processor and a non-transitory computer readable memory, the memory storing instructions that are operative, when executed on the processor:
to select, from among a plurality of participants in networked application, a participant with a low quality of experience;
to identify a type of network service that is predicted to improve the participant's quality of experience;
to select a plurality of service providers capable of providing the identified type of network service; and
to conduct a reverse auction between the selected participant and the selected plurality of service providers for the identified type of network service.

15. The server of claim 14, wherein the networked application is a multi-player networked game.

16. The server of claim 14, wherein the instructions operative to select the participant are operative:
to receive, from a plurality of participants, information identifying latency in the respective participants' use of the networked application; and
to select a participant with a latency above a threshold latency.

17. The server of claim 14, wherein the instructions operative to select the participant are operative:
to receive, from a plurality of participants, information identifying latency jitter in the respective participants' use of the networked application; and
to select a participant with a latency jitter above a threshold latency jitter.

18. The server of claim 14, wherein the instructions operative to identify the type of network service include instructions operative:
to determine an actual state of the networked application;
to determine a predicted state of the networked application using at least a first type of network service; and
to calculate a predicted quality of experience improvement with the use of the first type of network service.

19. The server of claim 14, wherein the identified type of network service is an application service, and wherein the instructions are operative to select application service providers within a predetermined geographic range of the selected participant.

20. The server of claim 14, wherein the identified type of network service is a connectivity service, and wherein the instructions are operative to select connectivity service providers capable of providing connectivity between the selected participant and an application service used by the selected participant.
